(19) United States
(12) Patent Application Publication
(10) Pub. No.: US 2008/0296984 A1
(43) Pub. Date: Dec. 4, 2008

(54) ENERGY CONVERTER

(75) Inventors: Kazunari Honma, Ogaki-shi (JP); Naoteru Matsubara, Ichinomiya-shi (JP); Yoshinori Shishida, Yoro-gun (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/128,884

(22) Filed: May 29, 2008

(30) Foreign Application Priority Data
May 29, 2007 (JP) 2007-141558
May 30, 2007 (JP) 2007-142716
May 8, 2008 (JP) 2008-121808

(51) Int. Cl. H02K 35/00

(52) U.S. Cl. 310/17

(57) ABSTRACT

This energy converter includes a first flat coil and a magnet opposed to the first flat coil at an interval, and the first flat coil and the magnet are so formed as to be relatively movable, for converting kinetic energy to electric energy by electromagnetic induction.

### CROSS-REFERENCE TO RELATED APPLICATIONS

The priority application number JP2007-141558, Energy Converter, May 29, 2007, Kazunari Honma, JP2007-142716, Electric Transducer and Sensor Unit loaded with this Electric Transducer, May 30, 2007, Naoteru Matsubara, and JP2008-121808, Energy Converter, May 8, 2008, Kazunari Honma, Naoteru Matsubara, Yoshinori Shisida upon which this patent application is based are hereby incorporated by reference.

### BACKGROUND OF THE INVENTION

1. Field of the Invention

The present invention relates to an energy converter, and more particularly, it relates to an energy converter converting kinetic energy to electric energy.

2. Description of the Background Art

An energy converter converting kinetic energy to electric energy is known in general.

In general, a linear power generator (energy converter) comprising a helically formed coil and a bar-shaped magnet arranged in the coil is disclosed. This magnet is so formed as to be movable across the helical coil. The linear power generator is so formed as to generate power by electromagnetic induction caused by the bar-shaped magnet moving across the coil in the helical coil.

### SUMMARY OF THE INVENTION

An energy converter according to a first aspect of the present invention comprises a first flat coil and a magnet opposed to the first flat coil at an interval, and the first flat coil and the magnet are so formed as to be relatively movable, for converting kinetic energy to electric energy by electromagnetic induction.

An energy converter according to a second aspect of the present invention comprises a first flat coil, a magnet opposed to the first flat coil at an interval, a charge holding film arranged at an interval from the magnet and an electrode opposed to the charge holding film at an interval, the magnet and the first flat coil are so formed as to be relatively movable, and the charge holding film and the electrode are so formed as to be relatively movable, for converting kinetic energy to electric energy by electromagnetic induction caused between the magnet and the first flat coil while converting kinetic energy to electric energy by electrostatic induction caused between the charge holding film and the electrode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing the structure of a power generator according to a first embodiment of the present invention;

FIG. 2 is a plan view for illustrating the structure of the power generator according to the first embodiment shown in FIG. 1;

FIG. 3 is a diagram for illustrating the structure of the power generator according to the first embodiment shown in FIG. 1;

FIG. 4 is a sectional view for illustrating a power generating operation of the power generator according to the first embodiment of the present invention;

FIG. 5 is a sectional view showing the structure of a power generator according to a second embodiment of the present invention;

FIG. 6 is a plan view for illustrating the structure of the power generator according to the second embodiment shown in FIG. 5;

FIG. 7 is a block diagram showing the structure of a vibration sensor according to a third embodiment of the present invention;

FIG. 8 is a sectional view showing the structure of a power generator according to a fourth embodiment of the present invention;

FIG. 9 is a plan view showing the layout of a D layer in the power generator shown in FIG. 8;

FIG. 10 is a plan view showing the layout of an E layer in the power generator shown in FIG. 8;

FIG. 11 is a plan view showing the layout of an F layer in the power generator shown in FIG. 8;

FIG. 12 is a plan view showing the layout of a G layer in the power generator shown in FIG. 8;

FIG. 13 is a sectional view showing the structure of a power generator according to a fifth embodiment of the present invention;

FIG. 14 is a block diagram showing the structure of a sensor unit provided with a power generator according to a sixth embodiment of the present invention;

FIG. 15 is a block diagram showing the structure of a sensor unit provided with a power generator according to a seventh embodiment of the present invention;

FIG. 16 is a diagram for illustrating the structure of a power generator according to a first modification of the first embodiment of the present invention;

FIG. 17 is a diagram for illustrating the structure of a power generator according to a second modification of the first embodiment of the present invention;

FIG. 18 is a sectional view showing the structure of a power generator according to a third modification of the first embodiment of the present invention;

FIG. 19 is a sectional view showing the structure of a power generator according to a fourth modification of the first embodiment of the present invention;

FIG. 20 is a sectional view showing the structure of a power generator according to a fifth modification of the first embodiment of the present invention;

FIG. 21 is a plan view showing the structure of the power generator shown in FIG. 20;

FIG. 22 is a sectional view showing the structure of a power generator according to a sixth modification of the first embodiment of the present invention;

FIG. 23 is a plan view showing the structure of the power generator shown in FIG. 22;

FIG. 24 is a sectional view showing the structure of a power generator according to a seventh modification of the first embodiment of the present invention;

FIG. 25 is a sectional view showing the structure of a power generator according to an eighth modification of the first embodiment of the present invention; and

FIG. 26 is a sectional view showing the structure of a power generator according to a ninth modification of the first embodiment of the present invention.

### DESCRIPTION OF THE PREFERRED EMBODIMENTS

Embodiments of the present invention are now described with reference to the drawings.

### First Embodiment

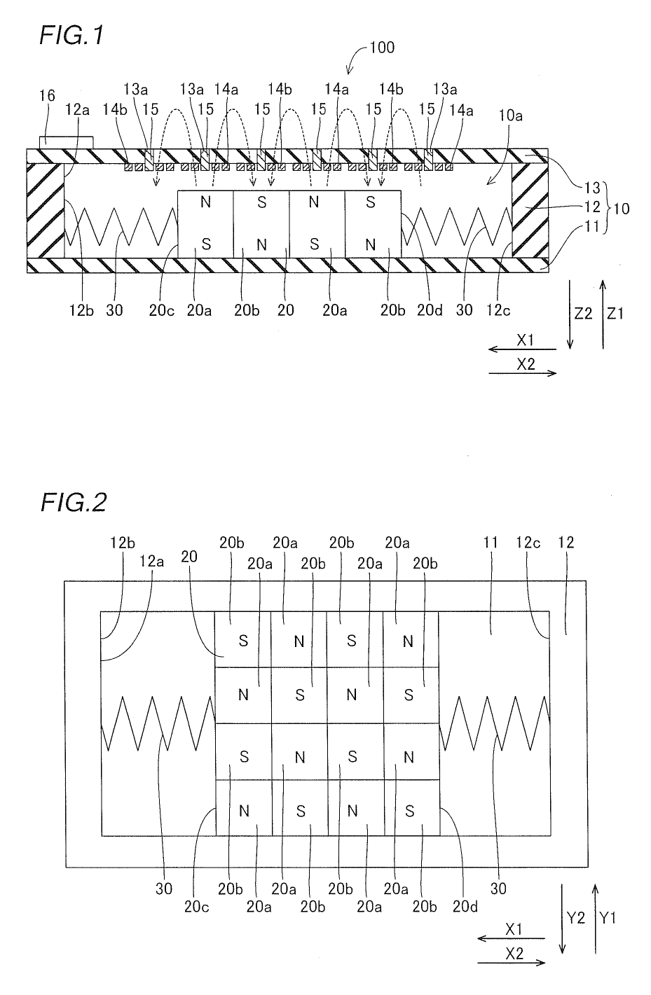

First, the structure of a power generator 100 according to a first embodiment of the present invention is described with reference to FIGS. 1 to 3. According to the first embodiment, the present invention is applied to the power generator 100 which is an exemplary energy converter converting kinetic energy to electric energy.

The power generator 100 according to the first embodiment of the present invention comprises a support 10 provided with a storage portion 10a as well as a permanent magnet 20 and coil springs 30 arranged in the storage portion 10a, as shown in FIG. 1. The permanent magnet 20 is an example of the “magnet” in the present invention, and the coil springs 30 are examples of the “first urging means” in the present invention.

The support 10 is constituted of printed boards 11, 12 and 13. More specifically, the printed board 12 having an opening 12a is formed on the upper surface of the printed board 11. This opening 12a has a substantially rectangular (oblong) shape in plan view, as shown in FIG. 2. The printed board 13 is formed on the upper surface of the printed board 12 to cover the opening 12a, as shown in FIG. 1. In the support 10, therefore, the opening 12a of the printed board 12 arranged between the printed boards 11 and 13 forms the storage portion 10a.

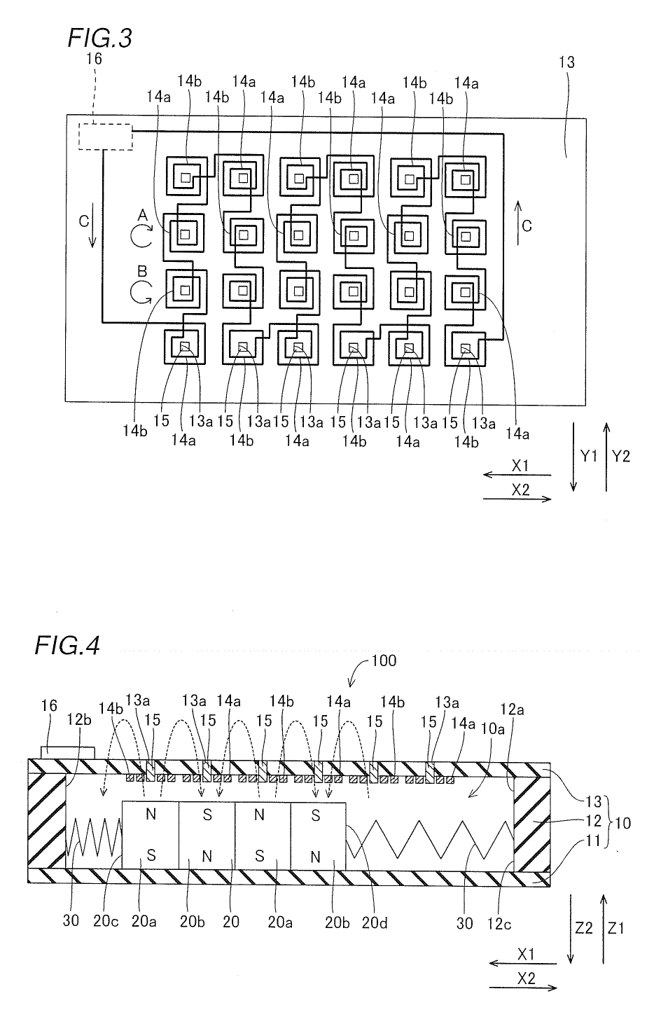

According to the first embodiment, flat coils 14a and 14b are formed on the lower surface of the printed board 13. The flat coils 14a and 14b are arranged in a checkered manner and convolutely formed as viewed from below, as shown in FIG. 3. FIGS. 1 and 3 only partially show the plurality of (e.g., 50) flat coils 14a and the plurality of (e.g., 50) flat coils 14b, in order to simplify the illustration. The flat coils 14a and 14b are wound in directions opposite to each other. More specifically, the flat coils 14a are wound counterclockwise outwardly as viewed from below, while the flat coils 14b are wound clockwise outwardly as viewed from below. The flat coils 14a and 14b are so alternately connected with each other that the plurality of flat coils 14a and the plurality of flat coils 14b are serially connected with each other. More specifically, the inner side of each flat coil 14a (14b) is connected to the outer side of a first flat coil 14b (14a) adjacent to the flat coil 14a (14b), while the outer side of each flat coil 14a (14b) is connected to the inner side of a second flat coil 14b (14a) adjacent to the flat coil 14a (14b). Therefore, the flat coils 14a and 14b are so connected with each other that induced electromotive force generated in the flat coils 14a and 14b is not canceled. The flat coils 14a and 14b are examples of the “first flat coil” in the present invention, the flat coils 14a are examples of the “counterclockwise coil portion” or the “coil portion” in the present invention, and the flat coils 14b are examples of the “clockwise coil portion” or the “coil portion” in the present invention.

According to the first embodiment, the printed board 13 is provided with openings 13a on regions corresponding to the centers of the flat coils 14a and 14b respectively. Cores 15 of Fe or Co are embedded in the openings 13a. The cores 15 are so formed as to protrude from the lower surface of the printed board 13, and arranged at the centers of the flat coils 14a and 14b. The cores 15 are electrically isolated from the flat coils 14a and 14b.

As shown in FIG. 1, a circuit portion 16 for controlling and outputting the induced electromotive force generated in the flat coils 14a and 14b is provided on the upper surface of the printed board 13. This circuit portion 16 is connected with the serially connected plurality of flat coils 14a and 14b.

According to the first embodiment, the permanent magnet 20 is arranged in the storage portion 10a to be movable along arrow X1 (along arrow X2), as shown in FIGS. 1 and 2. Movement of the permanent magnet 20 along arrow Y1 (along arrow Y2) is regulated, as shown in FIG. 2. The permanent magnet 20 is in the form of a flat sheet (plate) and opposed to the flat coils 14a and 14b at a prescribed interval, as shown in FIG. 1. This permanent magnet 20 includes portions (domains) 20a magnetized along arrow Z1 and portions 20b magnetized along arrow Z2, and is constituted as a multipolar magnet. Therefore, magnetic fields indicated by magnetic lines of force shown by broken lines in FIG. 1 are formed in the vicinity of the printed board 13. The portions 20a and 20b are arranged in an alternately adjacent state (in a checkered manner) in plan view, as shown in FIG. 2. FIGS. 1 and 2 only partially show the plurality of (e.g., 50) portions 20a and the plurality of (e.g., 50) portions 20b, in order to simplify the illustration. When the permanent magnet 20 is arranged on a reference position, the portions 20a are arranged on regions corresponding to the flat coils 14a while the portions 20b are arranged on regions corresponding to the flat coils 14b, as shown in FIG. 1. The portions 20a and 20b are examples of the “first portion” and the “second portion” in the present invention respectively.

According to the first embodiment, the coil springs 30 are arranged between a side surface 12b of the opening 12a and an end 20c of the permanent magnet 20 and between another side surface 12c of the opening 12a and another end 20d of the permanent magnet 20 respectively, as shown in FIGS. 1 and 2. The pair of coil springs 30 have a function of urging the permanent magnet 20, for arranging the same on the prescribed reference position with respect to the support 10 along arrow X1 (along arrow X2).

A power generating operation of the power generator 100 according to the first embodiment is now described with reference to FIGS. 1, 3 and 4.

When arranged on the prescribed reference position with respect to the support 10 as shown in FIG. 1, the permanent magnet 20 forms the magnetic fields substantially along arrow Z1 on the regions where the flat coils 14a are positioned, while forming the magnetic fields substantially along arrow Z2 on the regions where the flat coils 14b are positioned.

When the permanent magnet 20 moves along arrow X1 with respect to the support 10 due to force applied to the power generator 100 as shown in FIG. 4, the direction of the magnetic fields on the regions where the flat coils 14a are positioned changes substantially along arrow Z2, while the direction of the magnetic fields on the regions where the flat coils 14b are positioned changes substantially along arrow Z1. At this time, induced currents forming magnetic fields along arrow Z1 are generated in the flat coils 14a while induced currents forming magnetic fields along arrow Z2 are generated in the flat coils 14b due to electromagnetic induction. In other words, induced currents along arrow A are generated in the flat coils 14a while induced currents along arrow B are generated in the flat coils 14b, as shown in FIG. 3. Therefore, the plurality of serially connected flat coils 14a and 14b supply an induced current in a direction C to the circuit portion 16.

When the permanent magnet 20 moves along arrow X2 with respect to the support 10 due to the urging force of the coil springs 30 as shown in FIG. 1, the direction of the magnetic fields on the regions where the flat coils 14a are positioned changes substantially along arrow Z1, while the magnetic fields on the regions where the flat coils 14b are positioned changes substantially along arrow Z2. At this time, induced currents forming magnetic fields along arrow Z2 are generated in the flat coils 14a while induced currents forming magnetic fields along arrow Z1 are generated in the flat coils 14b due to electromagnetic induction. In other words, induced currents along arrow B are generated in the flat coils 14a while induced currents along arrow A are generated in the flat coils 14b, as shown in FIG. 3. Therefore, the plurality of serially connected flat coils 14a and 14b supply an induced current opposite to the direction C to the circuit portion 16.

Thereafter the power generator 100 repeats the aforementioned operation, to continuously generate power.

The induced electromotive force V generated in each flat coil 14a (14b) due to electromagnetic induction can be expressed as follows:

V=−N×dφ/dt

where N represents the number of turns of the flat coil 14a (14b), φ represents a magnetic flux passing through the flat coil 14a (14b), and t represents time.

According to the first embodiment, as hereinabove described, the power generator 100 is provided with the flat coils 14a and 14b and the flat permanent magnet 20 in the form of a flat sheet while the permanent magnet 20 is opposed to the flat coils 14a and 14b at the prescribed interval, whereby the thickness of the power generator 100 can be reduced as compared with a power generator formed by arranging bar-shaped magnets in helical coils.

According to the first embodiment, the flat coils 14a and 14b are formed on the lower surface of the printed board 13, whereby the same can be easily formed as compared with stereoscopically shaped helical coils.

According to the first embodiment, the power generator 100 is provided with the coil springs 30 urging the permanent magnet 20 for arranging the same on the prescribed reference position, whereby the permanent magnet 20 can easily vibrate with respect to the support 10 when force is applied to the power generator 100.

According to the first embodiment, the plurality of flat coils 14a and 14b are serially connected with each other, whereby high induced electromotive force can be obtained.

According to the first embodiment, the cores 15 are so provided on the centers of the flat coils 14a and 14b that the magnetic fluxes φ passing through the flat coils 14a and 14b can be increased, whereby the quantity of power generated in the power generator 100 can be increased.

According to the first embodiment, as hereinabove described, the flat coils (counterclockwise coil portions) 14a and the flat coils (clockwise coil portions) 14b are so alternately connected with each other that the induced electromotive force generated in the flat coils 14a and 14b is not canceled. Thus, high induced electromotive force can be obtained.

According to the first embodiment, as hereinabove described, the inner sides of either the plurality of flat coils (counterclockwise coil portions) 14a or the plurality of flat coils (clockwise coil portions) 14b and the outer sides of either the plurality of flat coils (clockwise coil portions) 14b or the plurality of flat coils (counterclockwise coil portions) 14a are so connected with each other that the induced electromotive force generated in the flat coils 14a and 14b is not canceled. Thus, high induced electromotive force can be obtained.

According to the first embodiment, as hereinabove described, the flat coils 14a and 14b are convolutely formed in plan view, whereby the thickness of the body of the power generator 100 can be reduced dissimilarly to a case of forming the coils 14a and 14b in a stereoscopic shape such as a helical shape.

### Second Embodiment

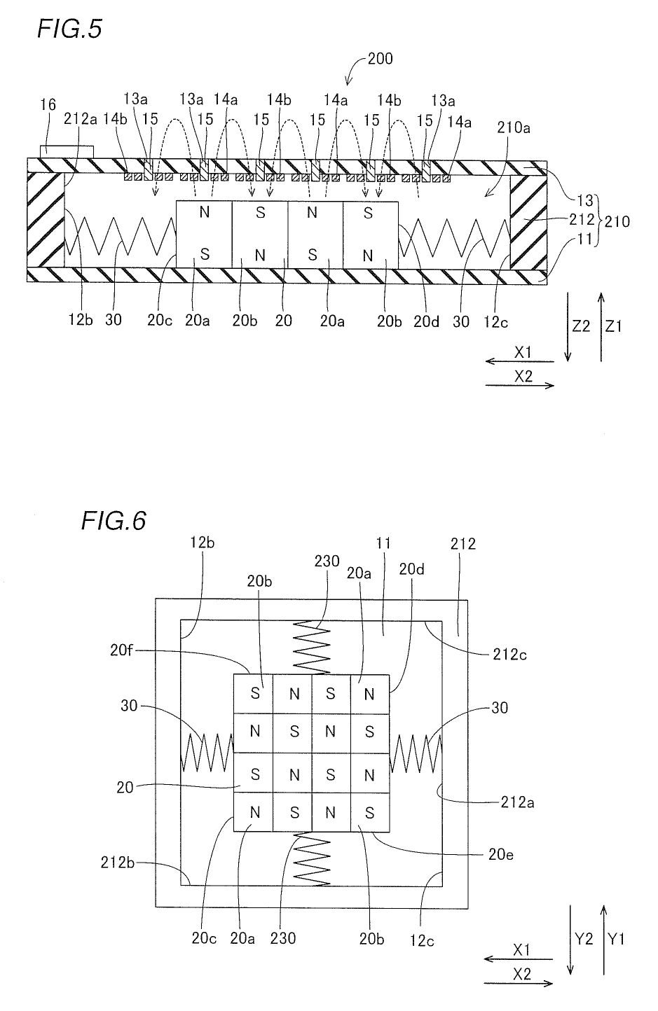

Referring to FIGS. 5 and 6, a power generator 200 according to a second embodiment of the present invention has a permanent magnet 20 also movable along arrow Y1 (along arrow Y2), dissimilarly to the aforementioned first embodiment.

The power generator 200 according to the second embodiment of the present invention comprises a support 210 provided with a storage portion 210a and coil springs 30 and 230 (see FIG. 6), as shown in FIG. 5. The coil springs 230 are examples of the “second urging means” in the present invention.

The support 210 is constituted of printed boards 11, 212 and 13. More specifically, the printed board 212 having an opening 212a is formed on the upper surface of the printed board 11. This opening 212a has a substantially rectangular (oblong) shape in plan view, as shown in FIG. 6. The printed board 13 is formed on the upper surface of the printed board 212 to cover the opening 212a, as shown in FIG. 5. In the support 210, therefore, the opening 212a of the printed board 212 arranged between the printed boards 11 and 13 forms the storage portion 210a.

According to the second embodiment, the coil springs 230 are arranged between a side surface 212b of the opening 212a and an end 20e of the permanent magnet 20 and between another side surface 212c of the opening 212a and another end 20f of the permanent magnet 20 respectively, as shown in FIG. 6. The pair of coil springs 230 have a function of urging the permanent magnet 20, for arranging the same on a prescribed reference position with respect to the support 210 along arrow Y1 (along arrow Y2).

The remaining structure of the second embodiment is similar to that of the aforementioned first embodiment.

A power generating operation of the power generator 200 according to the second embodiment is now described with reference to FIGS. 5 and 6.

When the permanent magnet 20 moves along arrow X1 (along arrow X2) with respect to the support 210 (see FIG. 5) as shown in FIG. 6 due to force applied to the power generator 200, the power generator 200 generates power similarly to the power generator 100 according to the aforementioned first embodiment. Also when the permanent magnet 20 moves along arrow Y1 (along arrow Y2) with respect to the support 210 due to another force applied to the power generator 200, the power generator 200 generates power similarly to the case where the permanent magnet 20 moves along arrow X1 (along arrow X2).

According to the second embodiment, as hereinabove described, the coil springs 230 are so formed as to urge the permanent magnet 20 in the direction (along arrows Y1 and Y2) perpendicular to the direction (along arrows X1 and X2) in which the coil springs 30 urge the permanent magnet 20. Also when the permanent magnet 20 moves along arrow Y1 (along arrow Y2) with respect to the support 210 due to the force applied to the power generator 200, therefore, the power generator 200 generates power similarly to the case where the permanent magnet 20 moves along arrow X1 (along arrow X2).

According to the second embodiment, as hereinabove described, flat coils 14a and 14b as well as portions 20a and 20b are arranged in a checkered manner, whereby the power generator 200 can generate power not only when the permanent magnet 20 moves along arrow X1 (along arrow X2) with respect to the support 210 but also when the permanent magnet 20 moves along arrow Y1 (along arrow Y2) with respect to the support 210.

The remaining effects of the second embodiment are similar to those of the aforementioned first embodiment.

### Third Embodiment

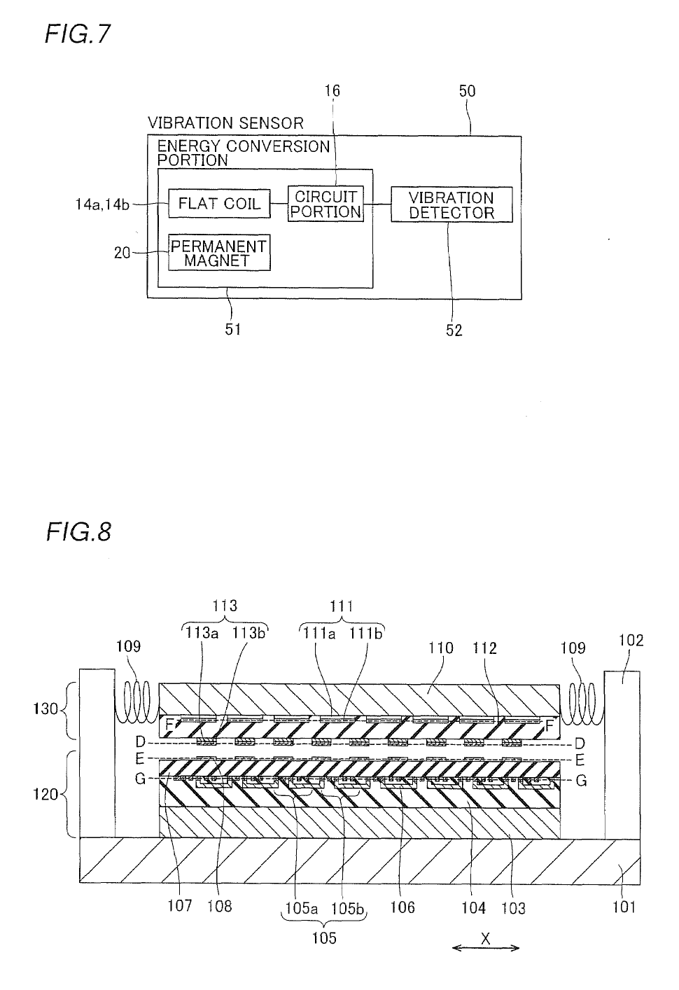

Referring to FIG. 7, a third embodiment of the present invention is applied to a vibration sensor 50 employed as an exemplary energy converter converting kinetic energy to electric energy, dissimilarly to the aforementioned first and second embodiments. This vibration sensor 50 comprises an energy conversion portion 51 and a vibration detector 52. The energy conversion portion 51 has a structure similar to that of the power generator 100 or 200 according to the aforementioned first or second embodiment, and is so formed that a circuit portion 16 is connected to the vibration detector 52. The vibration detector 52 is so formed as to detect vibration when a voltage or a current output from the circuit portion 16 exceeds a threshold.

### Fourth Embodiment

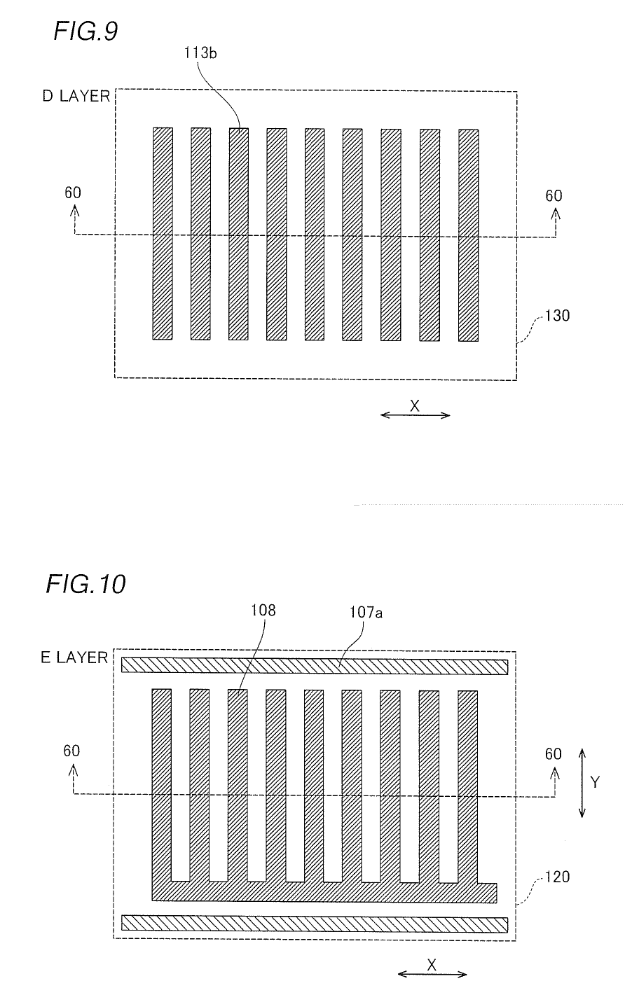

Referring to FIGS. 8 to 12, a power generator according to a fourth embodiment of the present invention comprises counter electrodes 108 serving as collecting electrodes and electret electrodes 113 between magnet portions 111 and flat coils 105, dissimilarly to the aforementioned first embodiment. The counter electrodes 108 are examples of the “electrode” in the present invention, and the electret electrodes 113 are examples of the “charge holding film” in the present invention. FIG. 12 also shows bridge wiring layers 106 connecting adjacent flat coils 105 with each other. D to G layers in FIG. 8 correspond to sectional views taken along the lines 60-60 in FIGS. 9 to 12 respectively.

In the power generator according to the fourth embodiment, a fixed portion 120 and a movable portion 130 are arranged at a prescribed interval. The fixed portion 120 is fixed onto a printed board 101, and the movable portion 130 is coupled to a fixed structure 102 provided on the printed board 101 through spring members 109. As shown in FIG. 8, the spring members 109 are connected to both side surfaces of the movable portion 130, and the movable portion 130 can horizontally move in a prescribed direction (along arrow X) and return to a constant position due to the spring members 109.

The E layer provided with the plurality of counter electrodes 108 and the G layer provided with the plurality of flat coils 105 are stacked on the fixed portion 120. More specifically, the fixed portion 120 is constituted of a substrate 103, an insulating layer 104 formed on the upper surface of the substrate 103, the plurality of flat coils 105 (G layer) embedded in the insulating layer 104, another insulating layer 107 formed on the upper surface of the insulating layer 104 (flat coils 105) and the plurality of counter electrodes 108 (E layer) formed on the upper surface of the insulating layer 107 at prescribed intervals along arrow X.

The D layer provided with the plurality of electret electrodes 113 and the F layer provided with the plurality of magnet portions 111 are stacked on the movable portion 130. More specifically, the movable portion 130 is constituted of a substrate 110, the plurality of magnet portions 111 arranged on the lower surface of the substrate 110, an insulating layer 112 so formed as to cover the magnet portions 111 and the plurality of electret electrodes 113 arranged on the lower surface of the insulating layer 112.

According to the fourth embodiment, further, all of the layers (D to G layers) provided on the fixed portion 120 and the movable portion 130 are so provided as to overlap with each other in plan view. In particular, the D layer (electret electrodes 113) and the E layer (counter electrodes 108) are arranged in a state held between the F layer (magnet portions 111) and the G layer (flat coils 105).

Two types of power generating portions in the power generator according to the fourth embodiment are now described.

The electret electrodes 113 and the counter electrodes 108 of the D and E layers constituting one of the power generating portions are arranged at prescribed intervals from each other. An electrostatic induction type power generating portion generating power (converting vibrational energy (kinetic energy) to electric energy) through electrostatic induction is formed between the electret electrodes 113 and the counter electrodes 108 opposed to each other.

More specifically, when the movable portion 130 moves due to externally applied vibration, overlapping areas are increased/decreased between the electret electrodes 113 holding charges and the counter electrodes 108 opposed to the electret electrodes 113 in this electrostatic induction type power generating portion. Thus, changes of charges take place in the counter electrodes 108, whereby the power generating portion generates power by extracting these changes. The electrostatic induction type power generating portion generates power through electrostatic induction resulting from relative movement between the opposed electrodes 113 and 108, to exhibit extremely large output impedance. Therefore, this power generating portion can output a high voltage (about 100 V, for example) in a small shape. Further, the output voltage can be easily increased by increasing the initial charge injection quantity of the electret electrodes 113.

On the other hand, the magnet portions 111 and the flat coils 105 of the F and G layers constituting the other power generating portion are arranged at a prescribed interval from each other. An electromagnetic induction type power generating portion generating power (converting vibrational energy (kinetic energy) to electric energy) through electromagnetic induction is formed by the magnet portions 111 and the flat coils 105 opposed to each other.

More specifically, when the movable portion 130 moves due to externally applied vibration, induced electromotive force is generated in the flat coils 105 due to electromagnetic induction (Faraday's law of electromagnetic induction) between the same and pole faces of the magnet portions 111 in this electromagnetic induction type power generating portion. The power generating portion generates power by extracting this induced electromotive force. The electromagnetic induction type power generating portion generates power through the electromagnetic induction caused between the magnet portions 111 and the flat coils 105, and is suitable for outputting a low voltage (about 3 V, for example).

The respective layers (D to G layers) provided on the fixed portion 120 and the movable portion 130 are now described.

The D layer is provided with the electret electrodes 113. More specifically, the electret electrodes 113 are constituted of fixed electrodes 113a made of metal such as an aluminum alloy and electret films 113b made of a charge holding material (material semipermanently holding charges) formed on the surfaces of the fixed electrodes 113a. The plurality of electret electrodes 113 are so formed as to linearly (oblongly) extend in a direction perpendicular to the prescribed direction (along arrow X), as shown in FIG. 9. A resin material such as PTFE (polytetrafluoroethylene), PFA (tetrafluoroethylene perfluoroalkyl vinyl ether polymer), PP (polypropylene) or PET (polyethylene terephthalate), for example, is employed for the electret films 113b. Alternatively, an inorganic material such as silicon oxide or silicon nitride is employed for the electret films 113b. Charges are injected into the electret films 113b by corona discharge or the like, so that the surface potentials of the electret films 113b reach −100 V. The fixed electrodes 113a constituting the electret electrodes 113 are grounded. The surface potentials of the electret films 113b can be easily adjusted by selecting the material therefor or conditions of charge injection into the electret films 113b.

The E layer is provided with the counter electrodes 108. More specifically, the counter electrodes 108 are made of metal such as an aluminum alloy identically to the fixed electrodes 113a, and formed on the upper surface of the insulating layer 107, to be opposed to the electret electrodes 113. The counter electrodes 108 are grounded, and constitute the electrostatic induction type power generating portion generating power (converting vibrational energy to electric energy) through electrostatic induction along with the electret electrodes 113. The counter electrodes 108 are interdigitally formed in plan view by linear (oblong) portions and a portion connecting the oblong portions with each other, as shown in FIG. 10. The electret electrodes 113 and the counter electrodes 108 are opposed to each other. More specifically, the counter electrodes 108 are identical in size/pitch to the electret electrodes 113. The size (width) of the oblong portions of the counter electrodes 108 is optimally about 0.01 mm to 2 mm, particularly optimally about 0.1 mm. A large area change can be caused also with respect to small vibration due to fragmentation into such narrow oblong portions, whereby power generation efficiency with respect to the prescribed direction (along arrow X) can be improved.

In the E layer, spacers 107a (see FIG. 10) having a larger height than the counter electrodes 108 are provided on the upper surface of the insulating layer 107, in order to prevent the counter electrodes 108 and the electret electrodes 113 from coming into contact with each other during the operation of the power generator. According to the fourth embodiment, the spacers 107a are arranged on two portions around the counter electrodes 108, as shown in FIG. 10.

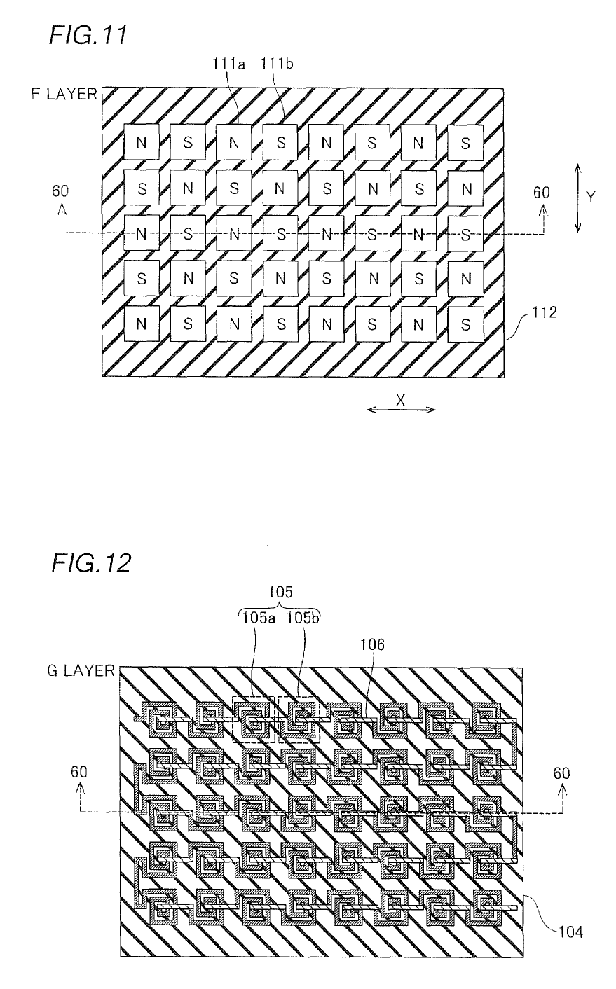

The F layer is provided with the magnet portions 111. More specifically, the magnet portions 111 are constituted of a plurality of neodymium-boron magnets (unipolar magnets), and so arranged that the pole faces (north poles 11a and south poles 111b) thereof are opposed to the flat coils 105. In the plurality of neodymium-boron magnets constituting the magnet portions 111, the pole faces (north poles 11a and south poles 111b) are alternately arranged in the form of a matrix, as shown in FIG. 11. The pole faces of the neodymium-boron magnets constituting the magnet portions 111 are so alternately arranged that magnetic flux changes can be increased with respect to vibration, whereby the quantity of power generated in electromagnetic induction can be increased.

The G layer is provided with the flat coils 105. More specifically, the flat coils 105 are made of gold (Au), copper (Cu), aluminum (Al) or tungsten (W). In the flat coils 105, counterclockwise coils 105a and clockwise coils 105b are alternately arranged in the form of a matrix while the bridge wiring layers 106 are provided for serially connecting the flat coils 105 with each other, as shown in FIG. 12. The flat coils 105 are arranged at the same pitch as the neodymium-boron magnets constituting the magnet portions 111 of the F layer. Assuming that each of the flat coils 105 and the neodymium-boron magnets has a square shape, the size (length) of each side thereof is optimally at least about 0.1 mm and not more than about 1 cm, particularly optimally about 1 mm. The reversely wound coils 105a and 105b are so alternately connected with each other as to prevent such a phenomenon that positive induced electromotive force and negative induced electromotive force generated in the flat coils 105 cancel each other and no induced electromotive force is generated from the adjacent flat coils 105 when the adjacent flat coils 105 are wound in the same direction.

While each flat coil 105 has two turns in FIG. 12, it is effective to increase the number of turns of the flat coil 105 in order to improve the quantity of power generation. Further, parasitic capacitances may be caused between the flat coils 105 and the counter electrodes 108 due to movement of the movable portion 130. Therefore, the interval between the flat coils 105 and the counter electrodes 108 is preferably increased at least beyond the interval between the electret electrodes 113 and the counter electrodes 108 by adjusting the thickness of the insulating layer 107. More preferably, the interval between the flat coils 105 and the counter electrodes 108 is set to about three times the interval between the electret electrodes 113 and the counter electrodes 108.

According to the fourth embodiment, as hereinabove described, the power generator further comprises the electrostatic induction type power generating portion in addition to the electromagnetic induction type power generating portion. When the movable portion 130 moves due to externally applied vibration, therefore, the power generator can simultaneously generate and supply two types of voltages (high and low voltages, for example) from single vibration. Therefore, the power generator requires no voltage converter (step-up/step-down circuit) as compared with a case of supplying two types of voltages with only a conventional power generator, and the power generator can be downsized (reduced in area).

According to the fourth embodiment, as hereinabove described, the power generator supplies two types of voltages (high and low voltages, for example) with no voltage converter (step-up/step-down circuit) to cause no power loss resulting from voltage conversion in a voltage converter (step-up/step-down circuit) dissimilarly to a conventional case of supplying two types of voltages by converting a high voltage to a low voltage, whereby the power generator is improved in power generation efficiency.

According to the fourth embodiment, as hereinabove described, the electromagnetic induction type power generating portion is formed by the magnet portions 111 and the flat coils 105 opposed to each other. Therefore, the electromagnetic induction type power generating portion can be mixedly provided on the power generator through common use of the materials (the fixed portion 120 and the movable portion 130) constituting the electrostatic induction type power generating portion, and the power generator can be downsized (reduced in area) as compared with a case of individually providing the electrostatic induction type power generating portion and the electromagnetic induction type power generating portion.

According to the fourth embodiment, as hereinabove described, the electrostatic induction type power generating portion and the electromagnetic induction type power generating portion are stacked, whereby the power generator can be further downsized (reduced in area) due to the overlapping regions of the power generating portions as compared with a case of providing the electrostatic induction type power generating portion and the electromagnetic induction type power generating portion on different positions of the respective members (the fixed portion 120 and the movable portion 130).

According to the fourth embodiment, as hereinabove described, the power generator is formed by stacking the electrostatic induction type power generating portion and the electromagnetic induction type power generating portion having the aforementioned structures. Therefore, the power generator is small-sized as compared with a conventional power generator generating power only by electromagnetic induction, and can supply two types of voltages (high and low voltages, for example).

### Fifth Embodiment

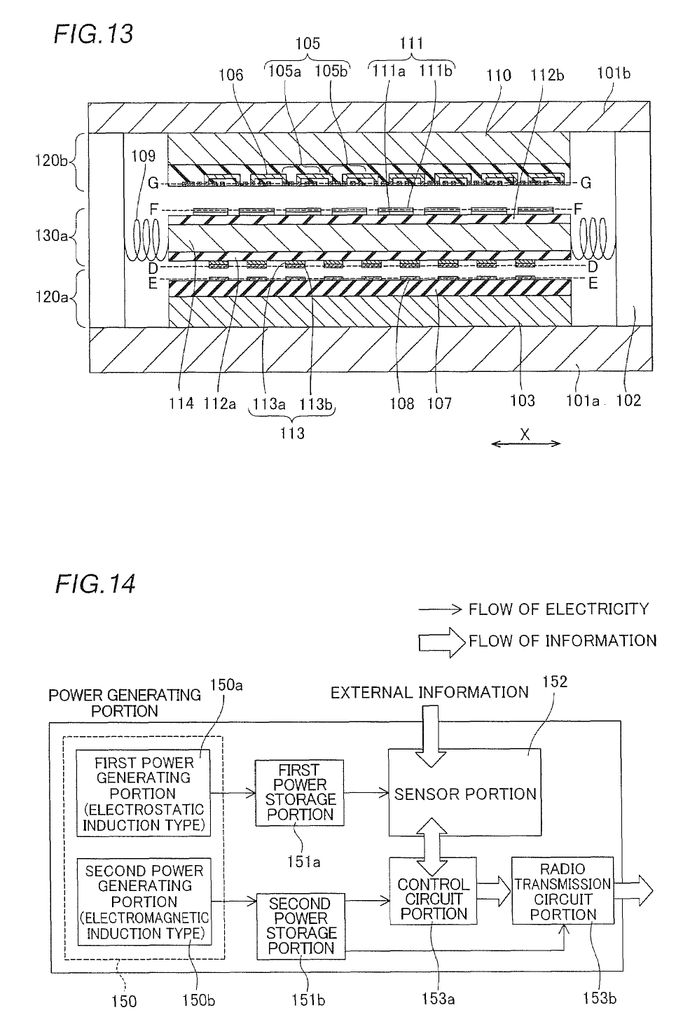

Referring to FIG. 13, an electrostatic induction type power generating portion is formed by opposing a first surface (lower surface) of a movable portion 130a and a first fixed portion 120a to each other and an electromagnetic induction type power generating portion is formed by opposing a second surface (upper surface) of the movable portion 130a and a second fixed portion 120b to each other in a power generator according to a fifth embodiment of the present invention, dissimilarly to the aforementioned fourth embodiment. The remaining structure of the power generator according to the fifth embodiment is similar to that of the fourth embodiment.

The power generator according to the fifth embodiment comprises the first fixed portion 120a, the second fixed portion 120b and the movable portion 130a held between the first and second fixed portions 120a and 120b at prescribed intervals. More specifically, the first fixed portion 120a is fixed onto a first printed board 101a, while the second fixed portion 120b is fixed to a second printed board 101b provided on a fixed structure 102. The movable portion 130a is held between the first and second fixed portions 120a and 120b. The movable portion 130a, the first fixed portion 120a and the second fixed portion 120b are arranged at the prescribed intervals respectively. The movable portion 130b is coupled to the fixed structure 102 through spring members 109. As shown in FIG. 13, the spring members 109 are connected to both side surfaces of the movable portion 130a, and the movable portion 130a can horizontally move in a prescribed direction (along arrow X) and return to a reference position due to the spring members 109.

In the movable portion 130a, a D layer provided with a plurality of electret electrodes 113 is arranged on the first surface (lower surface), and an F layer provided with a plurality of magnet portions 111 is arranged on the second surface (upper surface). More specifically, the movable portion 130a is constituted of a substrate 114, insulating layers 112a and 112b formed on both surfaces (upper and lower surfaces) of the substrate 114 respectively, the plurality of electret electrodes 113 arranged on the lower surface of the insulating layer 112a and the plurality of magnet portions 111 arranged on the upper surface of the insulating layer 112b.

An E layer provided with a plurality of counter electrodes 108 is arranged on the first fixed portion 120a. More specifically, the first fixed portion 120a is constituted of a substrate 103, an insulating layer 107 formed on the upper surface of the substrate 103 and the plurality of counter electrodes 108 (E layer) arranged on the upper surface of the insulating layer 107.

A G layer provided with a plurality of flat coils 105 is arranged on the second fixed portion 120b. More specifically, the second fixed portion 120b is constituted of a substrate 110, an insulating layer 104 formed on the lower surface of the substrate 110 and the plurality of flat coils 105 (G layer) arranged on the lower surface of the insulating layer 104.

In the power generator having the movable portion 130a, the first fixed portion 120a and the second fixed portion 120b arranged in the aforementioned manner, the electret electrodes 113 of the D layer and the counter electrodes 108 of the E layer are arranged at a prescribed interval from each other. The electrostatic induction type power generating portion generating power (converting vibrational energy to electric energy) through electrostatic induction is formed between the electret electrodes 113 and the counter electrodes 108 opposed to each other. Further, the magnet portions 111 of the F layer and the flat coils 105 of the G layer are arranged at a prescribed interval from each other. The electromagnetic induction type power generating portion generating power (converting vibrational energy to electric energy) through electromagnetic induction is formed between the magnet portions 111 and the flat coils 105 opposed to each other. This electromagnetic induction type power generating portion is arranged on a position overlapping the electrostatic induction type power generating portion through the movable portion 130a.

In the aforementioned power generator (energy converter) according to the fifth embodiment, the following effects can be attained in addition to the effects of the aforementioned fourth embodiment:

According to the fifth embodiment, as hereinabove described, the power generating portions are formed by holding the movable portion 130a between the two fixed portions 120a and 120b and opposing the respective ones of the two fixed portions 120a and 120b and the upper and lower surfaces of the movable portion 130a to each other respectively, whereby the freedom in design of the interval between the magnet portions 111 and the flat coils 105 is improved in the electromagnetic induction type power generating portion. Therefore, power generation characteristics in the electromagnetic induction type power generating portion can be controlled with no influence exerted by the size (height) of the electrostatic induction type power generating portion. Particularly according to the fifth embodiment, the interval between the magnet portions 111 and the flat coils 105 can be reduced as compared with the aforementioned fourth embodiment, whereby magnetic flux changes can be increased with respect to vibration. Further, the quantity of power generated in electromagnetic induction can be increased.

### Sixth Embodiment

Referring to FIG. 14, a sixth embodiment of the present invention is applied to a sensor unit (such as a sensor network unit, for example) loaded with the inventive power generator (energy converter).

The sensor unit according to the sixth embodiment comprises a power generating portion 150 (an electrostatic induction type first power generating portion 150a and an electromagnetic induction type second generating portion 150b) constituted of the aforementioned power generator, a first power storage portion 151a storing power generated in the first power generating portion 150a, a sensor portion 152 operating through the power stored in the first power storage portion 151a, a second power storage portion 151b storing power generated in the second power generating portion 150b and an electronic circuit portion (a control circuit portion 153a and a radio transmission circuit portion 153b) operating through the power stored in the second power storage portion 151b.

In this sensor unit, the power generating portion 150 self-generates power due to externally applied vibration, so that the electrostatic induction type first power generating portion 150a supplies a high voltage (about 100 V, for example) and the electromagnetic induction type second power generating portion 150b supplies a low voltage (about 3 V, for example). The sensor portion 152 operates through the power self-generated in the first power generating portion 150a, while the electronic circuit portion operates through the power self-generated in the second power generating portion 150b.

The aforementioned sensor unit loaded with the inventive power generator (energy converter) can attain the following effect:

According to the sixth embodiment, as hereinabove described, the sensor unit requires no voltage converter (step-up/step-down circuit) as compared with a conventional sensor unit operating through two types of voltages (high and low voltages, for example) supplied from an electrostatic induction type power generator, whereby the sensor unit can be downsized (reduced in area).

### Seventh Embodiment

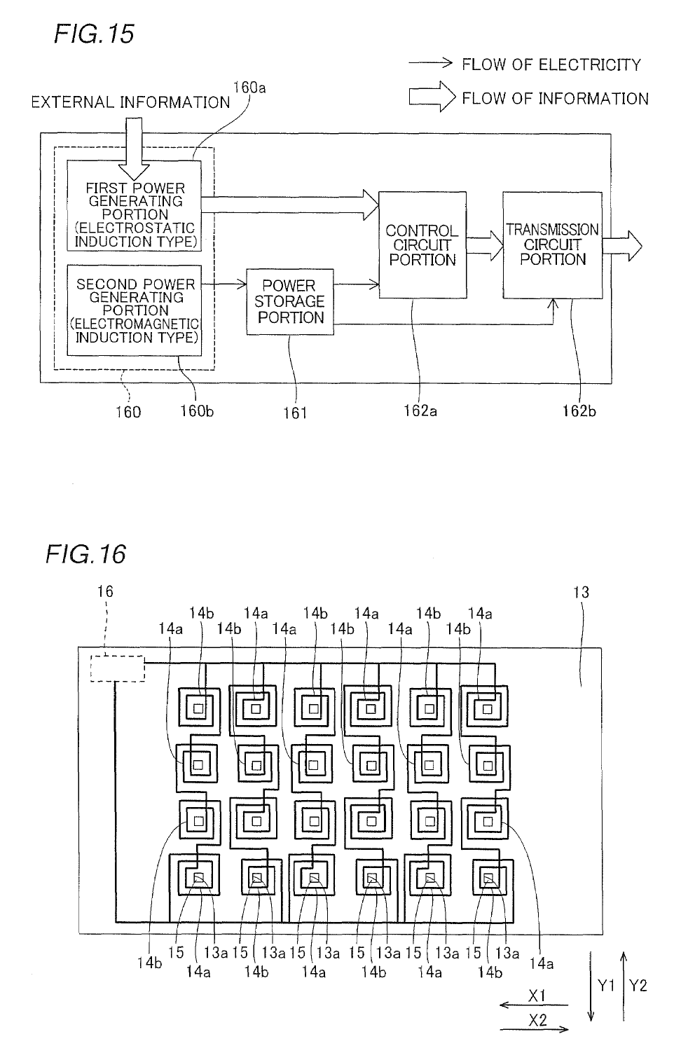

Referring to FIG. 15, a sensor unit according to a seventh embodiment of the present invention senses an electromotive voltage resulting from power self-generated in a first power generating portion 160a due to externally applied vibration so that the first power generating portion 160a functions as a sensor portion for external vibration, dissimilarly to the sixth embodiment. The remaining structure of the seventh embodiment is similar to that of the sixth embodiment.

The sensor unit according to the seventh embodiment comprises a power generating portion 160 (an electrostatic induction type first power generating portion 160a and an electromagnetic induction type second power generating portion 160b) constituted of the aforementioned power generator, a power storage portion 161 storing power generated in the second power generating portion 160b and an electronic circuit portion (a control circuit portion 162a and a transmission circuit portion 162b) operating through the power stored in the power storage portion 161.

This sensor unit detects vibration (momentum) by sensing the electromotive voltage resulting from power self-generated in the first power generating portion 160a, and operates the electronic circuit portion through power self-generated in the second power generating portion 160b.

The aforementioned sensor unit loaded with the inventive power generator (energy converter) can attain the following effect:

According to the seventh embodiment, as hereinabove described, the first power generating portion 160a itself functions as a sensor portion so that no sensor portion detecting external vibration may be separately loaded dissimilarly to the sixth embodiment, whereby the sensor unit can be downsized (reduced in area).

Although the present invention has been described and illustrated in detail, it is clearly understood that the same is by way of illustration and example only and is not to be taken by way of limitation, the spirit and scope of the present invention being limited only by the terms of the appended claims.

For example, while the plurality of serially connected flat coils 14a and 14b are provided in each of the aforementioned first and second embodiments, the present invention is not restricted to this but a plurality of flat coils 14a and 14b may be so provided that the respective columns of the plurality of flat coils 14a and 14b are serially connected with each other and the serially connected respective columns of the flat coils 14a and 14b are parallelly connected to a circuit portion 16, as in a first modification of the first embodiment shown in FIG. 16.

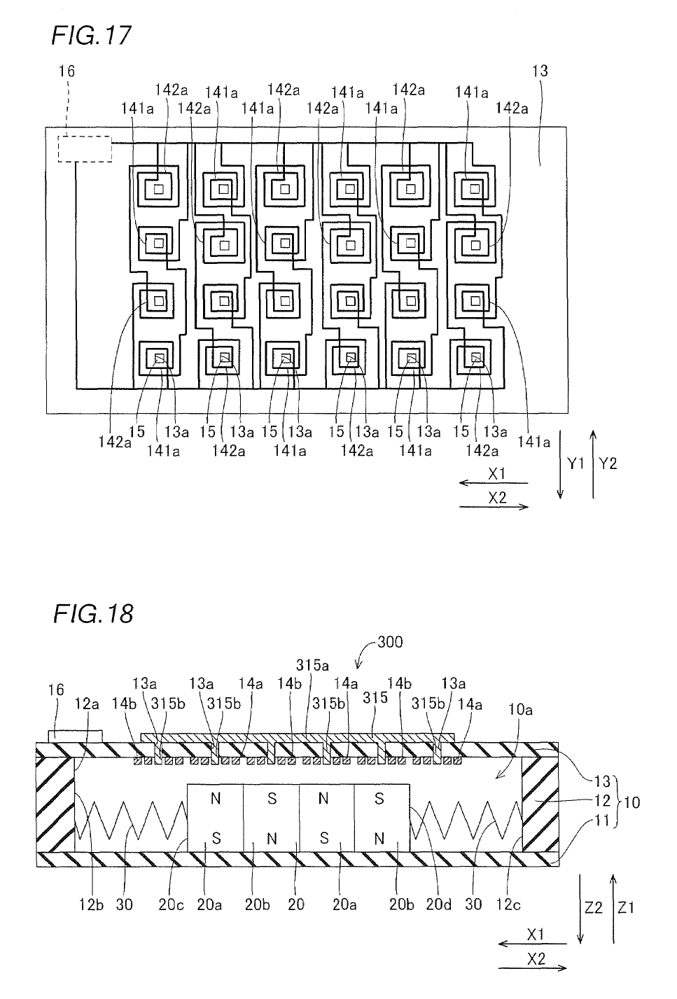

While the reversely wound flat coils 14a and 14b are provided so that the outer side of each flat coil 14a and the inner side of a first flat coil 14b adjacent to the flat coil 14a are connected with each other and the inner side of each flat coil 14a and the outer side of a second flat coil 14b adjacent to the flat coil 14a are connected with each other in each of the aforementioned first and second embodiments, the present invention is not restricted to this but only the flat coils 14a may alternatively be provided so that the inner sides of each flat coil 14a and a first flat coil 14a adjacent to the flat coil 14a are connected with each other and the outer sides of the flat coil 14a and a second flat coil 14a adjacent to the flat coil 14a are connected with each other. Further alternatively, flat coils 141a and 142a wound counterclockwise outwardly as viewed from below may be provided so that the respective columns of the plurality of flat coils 141a and 142a are serially connected with each other and the serially connected respective columns of the flat coils 141a and 142a are parallelly connected to a circuit portion 166, as in a second modification of the first embodiment shown in FIG. 17. The flat coils 141a and 142a are examples of the “first flat coil” in the present invention. Further alternatively, only flat coils wound clockwise outwardly as viewed from below may be provided.

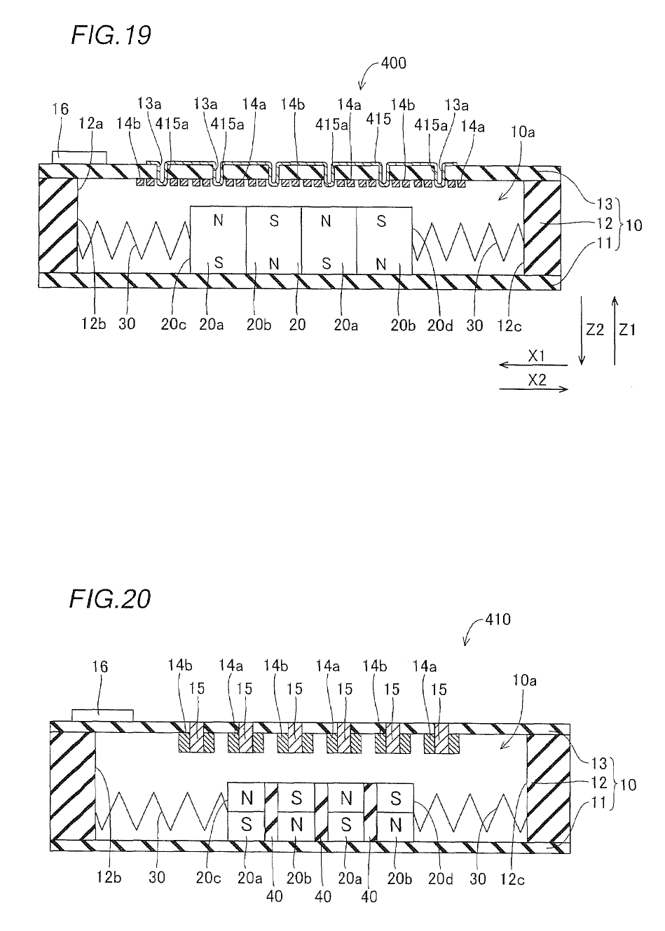

While the plurality of cores 15 are provided in each of the aforementioned first and second embodiments, the present invention is not restricted to this but a core 315 provided with a plurality of protrusions 315b on a platelike portion 315a arranged on the upper surface of a printed board 13 may alternatively be provided as in a power generator 300 according to a third modification of the first embodiment of the present invention shown in FIG. 18. The protrusions 315b are embedded in openings 13a of the printed board 13. According to this structure, the protrusions 315b arranged on the centers of flat coils 14a and 14b are properly magnetized, whereby the quantity of power generated in the power generator 300 can be increased. Further alternatively, a core 415 having protrusions 415a formed by press working or the like may be provided as in a power generator 400 according to a fourth modification of the first embodiment of the present invention shown in FIG. 19. The protrusions 415a are embedded in openings 13a of a printed board 13. According to this structure, the core 415 can be easily formed.

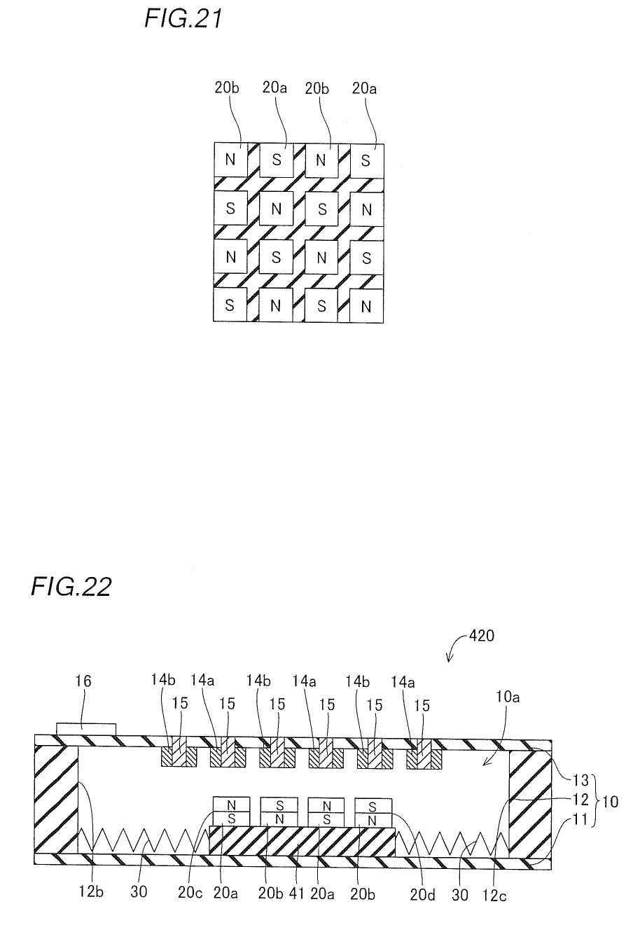

While the portions 20a and 20b of the permanent magnet 20 are adjacently arranged in each of the aforementioned first and second embodiments, the present invention is not restricted to this but spacers 40 may alternatively be provided between portions 20a and 20b of a permanent magnet 20 as in a power generator 410 according to a fifth modification of the first embodiment of the present invention shown in FIGS. 20 and 21. Thus, the density of magnetic fluxes passing through coils can be increased due to the spacers 40, whereby the quantity of power generated in the power generator 410 can be increased.

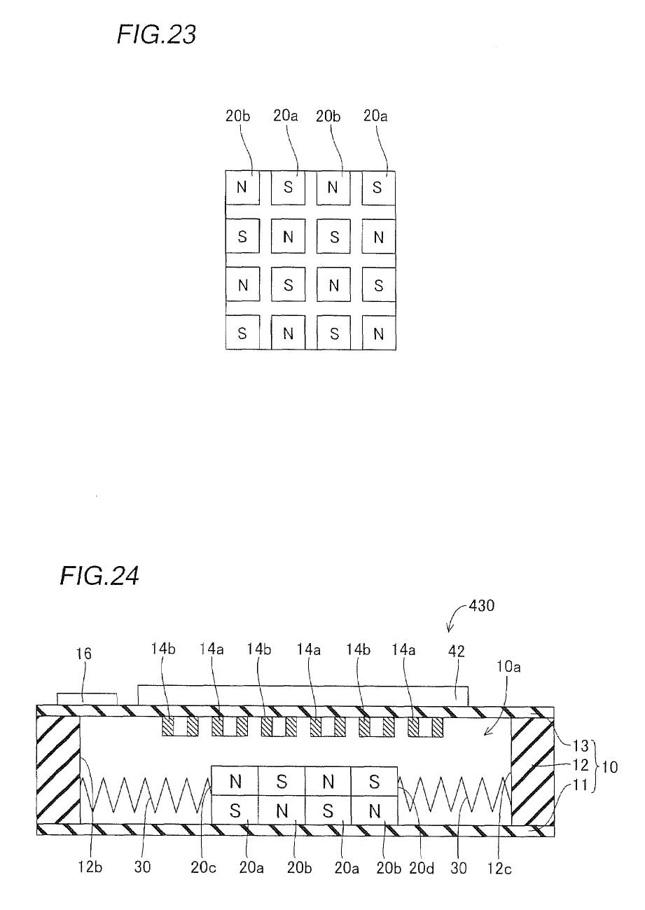

While the permanent magnet 20 is provided on the surface of the printed board 11 in each of the aforementioned first and second embodiments, the present invention is not restricted to this but a plurality of portions 20a and 20b of a permanent magnet 20 may alternatively be arranged on a substrate 41 in an alternately adjacent state to be relatively movable toward flat coils 14a and 14b, as in a power generator 420 according to a sixth modification of the first embodiment of the present invention shown in FIGS. 22 and 23. Thus, a multipolar magnet can be easily prepared by arranging a plurality of magnet portions. Further, the degree of freedom in design such as the arrangement of the permanent magnet 20 with respect to the substrate 41 can be improved.

While the flat coils 14a and 14b are provided on the lower surface of the printed board 13 closer to the permanent magnet 20 in each of the aforementioned first and second embodiments, the present invention is not restricted to this but a magnetic member 42 made of a magnetic material may alternatively be provided on the upper surface of a printed board 13 opposite to a permanent magnet 20 (on coils 14a and 14b) as in a power generator 430 according to a seventh modification of the first embodiment of the present invention shown in FIG. 24. Thus, the density of magnetic fluxes passing through the coils 14a and 14b can be increased, whereby the quantity of power generated in the power generator 430 can be improved. Further, no cores 15 may be arranged at the centers of the coils 14a and 14b, dissimilarly to the aforementioned first embodiment. In addition, magnetic leakage from the power generator 430 can be suppressed.

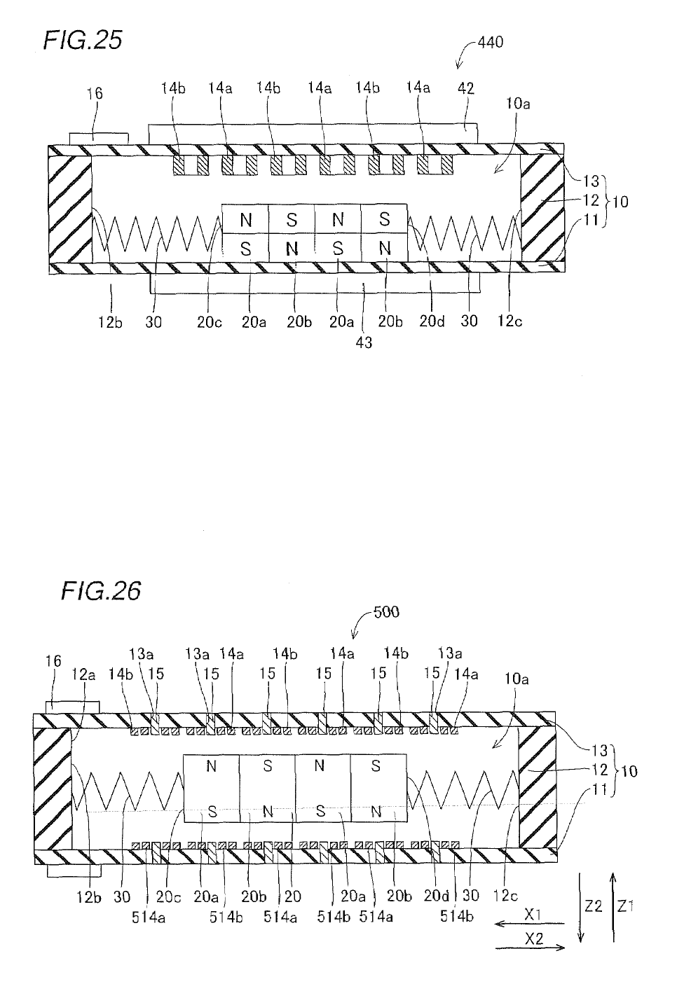

While the flat coils 14a and 14b are provided on the lower surface of the printed board 13 closer to the permanent magnet 20 in each of the aforementioned first and second embodiments, the present invention is not restricted to this but magnetic members 42 and 43 made of a magnetic material may alternatively be provided on the upper surface of a printed board 13 opposite to a permanent magnet 20 (on coils 14a and 14b) and the lower surface of a printed board 11 opposite to the permanent magnet 20 (under the permanent magnet 20) as in a power generator 440 according to an eighth modification of the first embodiment of the present invention shown in FIG. 25. Thus, effects similar to those of the aforementioned seventh modification can be attained, and magnetic leakage from the power generator 440 can be further suppressed.

While the flat coils 14a and 14b are formed on the printed board 13 in each of the aforementioned first and second embodiments, the present invention is not restricted to this but flat coils 14a and 14b and flat coils 514a and 514b may alternatively be formed on printed boards 13 and 11 respectively as in a power generator 500 according to a ninth modification of the first embodiment of the present invention shown in FIG. 26. According to this structure, the quantity of power generated in the power generator 500 can be easily increased. The flat coils 514a and 514b are examples of the “second flat coil” in the present invention. Further alternatively, flat coils may be formed only on the printed board 11.

While the permanent magnet 20 is arranged on the upper surface of the printed board 11 and the printed board 13 provided with the flat coils 14a and 14b is arranged on the upper surface of the permanent magnet 20 in each of the aforementioned first and second embodiments, the present invention is not restricted to this but the permanent magnet 20 may be arranged on the upper surface of the printed board 11, the printed board 13 provided with the flat coils 14a and 14b may be arranged on the upper surface of the permanent magnet 20, another permanent magnet 20 may be arranged on the upper surface of the printed board 13, and another printed board 11 may be arranged on the upper surface of the permanent magnet 20.

While the coil springs 30 are employed in each of the aforementioned first and second embodiments, the present invention is not restricted to this but other urging means such as plate springs may alternatively be employed in place of the coil springs 30. This also applies to the coil springs 230 in the second embodiment.

While the coil springs 30 and 230 support the permanent magnet 20 in the aforementioned second embodiment, the present invention is not restricted to this but the coil springs 230 may alternatively be omitted so that only the coil springs 30 support the permanent magnet 20.

While the flat coils 14a and 14b are provided on the support 10 (210) and the permanent magnet 20 is movably arranged with respect to the support 10 (210) in each of the aforementioned first and second embodiments, the present invention is not restricted to this but the permanent magnet 20 may alternatively be provided on the support 10 (210) and the flat coils 14a and 14b may alternatively be movably arranged with respect to the support 10 (210).

While the flat coils 14a and 14b are formed on the lower surface of the printed board 13 in each of the aforementioned first and second embodiments, the present invention is not restricted to this but the flat coils 14a and 14b may alternatively be formed on both of the upper and lower surfaces of the printed board 13. According to this structure, the quantity of power generated in the power generator 100 or 200 can be easily increased. Further alternatively, the flat coils 14a and 14b may be formed only on the upper surface of the printed board 13. In addition, the flat coils 14a and 14b may be partially or entirely embedded in the printed board 13.

While the permanent magnet 20 is constituted as a multipolar magnet in each of the aforementioned first and second embodiments, the present invention is not restricted to this but the permanent magnet 20 may alternatively be constituted of a plurality of bipolar magnets.

While the storage portion 10a is formed by the three printed boards 11, 12 and 13 in each of the aforementioned first and second embodiments, the present invention is not restricted to this but the storage portion 10a may alternatively be formed by other materials such as acrylic plates.

While the permanent magnet 20 is employed in each of the aforementioned first and second embodiments, the present invention is not restricted to this but an electromagnet may alternatively be employed in place of the permanent magnet 20.

While the portions 20a and 20b are arranged in a checkered manner in the aforementioned first embodiment, the present invention is not restricted to this but the portions 20a and 20b may alternatively be arranged in a striped manner. In this case, the flat coils 14a and 14b are preferably so connected with each other that induced electromotive force is not canceled.

While the electret electrodes are provided on the movable portion and the counter electrodes are provided on the fixed portion to constitute the electrostatic induction type power generating portion in each of the aforementioned fourth to seventh embodiments, the present invention is not restricted to this but the electret electrodes and the counter electrodes may alternatively be provided on the fixed portion and the movable portion respectively, for example. Effects similar to the above can be attained also in this case.

While the magnet portions are provided on the movable portion and the flat coils are provided on the fixed portion to constitute the electromagnetic induction type power generating portion in each of the aforementioned fourth to seventh embodiments, the present invention is not restricted to this but the magnet portions and the flat coils may alternatively be provided on the fixed portion and the movable portion respectively, for example. Effects similar to the above can be attained also in this case.

While the electrostatic induction type power generating portion and the electromagnetic induction type power generating portion are stacked in the power generator in each of the aforementioned fourth to seventh embodiments, the present invention is not restricted to this but the two power generating portions may alternatively be so arranged as not to planarly overlap with each other in a common member (movable portion and/or fixed portion), for example. Effects similar to the above can be attained also in this case.

While the spacers 107a are provided around the counter electrodes 108 in order to prevent the electret electrodes 113 and the counter electrodes 108 from coming into contact with each other during the operation of the power generator in the aforementioned fourth embodiment, the present invention is not restricted to this but a protective insulating layer covering the electret electrodes 113 and another protective insulating layer covering the counter electrodes 108 may alternatively be provided respectively, and the movable portion 130 may be so arranged that these protective insulating layers come into contact with each other, for example. In this case, the electret electrodes 113 and the counter electrodes 108 can be more reliably prevented from coming into contact with each other and the interval between the electret electrodes 113 and the counter electrodes 108 opposed to each other can be further reduced as compared with the case of employing the spacers 107a, whereby the quantity of power generated in the electrostatic induction type power generating portion can be improved.

What is claimed is:

1. An energy converter comprising:
a first flat coil; and
a magnet opposed to said first flat coil at an interval, wherein
said first flat coil and said magnet are so formed as to be relatively movable,
for converting kinetic energy to electric energy by electromagnetic induction.

2. The energy converter according to claim 1, further comprising:
a support provided with said first flat coil, and
first urging means urging said magnet toward a reference position.

3. The energy converter according to claim 2, further comprising second urging means urging said magnet toward said reference position, wherein
said second urging means is so formed as to urge said magnet in a direction intersecting with the direction in which said first urging means urges said magnet.

4. The energy converter according to claim 1, wherein
a plurality of said first flat coils are provided on the same plane, and
said plurality of first flat coils are arranged in the form of a matrix.

5. The energy converter according to claim 1, wherein
said magnet includes a first portion magnetized in a first direction intersecting with the surface of said first flat coil and a second portion magnetized in a second direction opposite to said first direction, and
said first portion and said second portion are arranged in a checkered manner.

6. The energy converter according to claim 1, further comprising a second flat coil provided on a side opposite to said first flat coil with respect to said magnet.

7. The energy converter according to claim 1, wherein
said magnet includes a first portion magnetized in a first direction intersecting with the surface of said first flat coil and a second portion magnetized in a second direction opposite to said first direction,
said first flat coil includes a clockwise coil portion arranged on a position corresponding to said first portion of said magnet and a counterclockwise coil portion arranged on a position corresponding to said second portion of said magnet, and
said clockwise coil portion and said counterclockwise coil portion are connected with each other.

8. The energy converter according to claim 1, wherein
a core is provided on a region corresponding to the center of said first flat coil.

9. The energy converter according to claim 4, further comprising a first magnetic member made of a magnetic material, wherein
said first magnetic member is provided on a position corresponding to said plurality of first flat coils on a side of said first flat coils opposite to the side provided with said magnet.

10. The energy converter according to claim 1, wherein
said magnet includes a plurality of first portions magnetized in a first direction intersecting with the surface of said first flat coil and a plurality of second portions magnetized in a second direction opposite to said first direction, and
said plurality of first portions and said plurality of second portions of said magnet are arranged on a substrate in a checkered manner at a prescribed interval.

11. The energy converter according to claim 10, further comprising a spacer arranged between said plurality of first portions and said plurality of second portions of said magnet.

12. The energy converter according to claim 1, further comprising a second magnetic member made of a magnetic material provided on a side of said magnet opposite to the side provided with said first flat coil.

13. The energy converter according to claim 1, wherein
said first flat coil includes a plurality of coil portions, and
said plurality of coil portions are so formed that respective columns of said plurality of coil portions are serially connected with each other and said serially connected respective columns of said plurality of coil portions are parallelly connected with each other in plan view.

14. The energy converter according to claim 1, wherein
said first flat coil is convolutely formed in plan view.

15. The energy converter according to claim 1, further comprising a sensor unit operating through electric energy converted by said energy converter.

16. The energy converter according to claim 1, further comprising:
a charge holding film arranged at an interval from said magnet, and
an electrode opposed to said charge holding film at an interval, wherein
said charge holding film and said electrode are so formed as to be relatively movable,
for converting kinetic energy to electric energy by electromagnetic induction caused between said magnet and said first flat coil while converting kinetic energy to electric energy by electrostatic induction caused between said charge holding film and said electrode.

17. An energy converter comprising:
a first flat coil;
a magnet opposed to said first flat coil at an interval;
a charge holding film arranged at an interval from said magnet; and
an electrode opposed to said charge holding film at an interval, wherein
said magnet and said first flat coil are so formed as to be relatively movable, and
said charge holding film and said electrode are so formed as to be relatively movable,
for converting kinetic energy to electric energy by electromagnetic induction caused between said magnet and said first flat coil while converting kinetic energy to electric energy by electrostatic induction caused between said charge holding film and said electrode.

18. The energy converter according to claim 17, wherein
said charge holding film is an electret, and
said electrode is a collecting electrode.
